(19) United States
(12) Patent Application Publication
(10) Pub. No.: US 2024/0392412 A1
(43) Pub. Date: Nov. 28, 2024

(54) USE OF ORGANIC ACID-CONTAINING LEACHING AGENT IN LEACHING FROM ION-ADSORPTION TYPE RARE EARTH ORE AND METHOD FOR LEACHING FULL-PHASE RARE EARTH

(71) Applicant: Institute of Process Engineering, CAS, Beijing (CN)

(72) Inventors: Tinggang Li, Beijing (CN); Mengfei Zhao, Beijing (CN); Zedong Teng, Beijing (CN)

(73) Assignee: Institute of Process Engineering, CAS, Beijing (CN)

(21) Appl. No.: 18/492,042

(22) Filed: Oct. 23, 2023

(30) Foreign Application Priority Data
May 22, 2023 (CN) 2023105752263

(51) Int. Cl. C22B 59/00; C22B 3/16

(52) U.S. Cl. CPC C22B 59/00; C22B 3/165

(57) ABSTRACT

Disclosed are use of an organic acid-containing leaching agent in leaching from an ion-adsorption type rare earth ore and method for leaching full-phase rare earth. A leaching agent containing a reducing organic acid or its compound leaching agent with a chemical leaching agent is used, and H⁺ or H⁺-cations in chemical leaching agent undergoes ion exchange so as to leach out an ion-exchangeable phase rare earth. Organic acid anions could complex with rare earth ions to reduce re-adsorption of rare earth ions onto clay minerals. The reducing organic acid could also realize dissolution and leaching of easily dissolved colloidal sediment phase rare earths and mineral phase rare earths. Rare earths that are difficult to dissolve are reduced by the reducing organic acid to form low-valent rare earth ions and leached out, thereby achieving simultaneous enhanced leaching of rare earths from ion-exchangeable phase, colloidal sediment phase, and mineral phase.

### CROSS REFERENCE TO RELATED APPLICATION

This patent application claims the benefit and priority of Chinese Patent Application No. 2023105752263, entitled “USE OF ORGANIC ACID-CONTAINING LEACHING AGENT IN LEACHING FROM ION-ADSORPTION TYPE RARE EARTHS ORE AND METHOD FOR LEACHING FULL-PHASE RARE EARTH” filed with the China National Intellectual Property Administration on May 22, 2023, the disclosure of which is incorporated by reference herein in its entirety as part of the present application.

### TECHNICAL FIELD

The present disclosure relates to the technical field of extraction of rare earth minerals, and in particular to use of an organic acid-containing leaching agent in leaching from an ion-adsorption type rare earth ores (IAREOs) and a method for leaching full-phase rare earth.

### BACKGROUND

Rare earth elements have unique optical, electrical, and magnetic properties, and are indispensable elements for infrastructure, technology, and modern life. In recent years, the demand for rare earths, especially heavy rare earths in the global market has grown dramatically. Ion-adsorption type rare earth ore (IAREO), a new type of exogenous rare earth deposit discovered in south of China, refers to rare earths that are adsorbed by an adsorbent in the form of ions and could be leached out through ion exchange. However, in addition to ion-exchangeable phase rare earths that could be exchanged through ion exchange, there are also colloidal sediment phase rare earths and mineral phase rare earths that exist in the form of hydroxides, carbonates, or a combination with colloidal particles in the soil. The ion-exchangeable phase rare earths account for about 62 wt % to 90 wt % of full-phase rare earth, while the colloidal sediment phase rare earths and mineral phase rare earths account for about 10 wt % to 38 wt %.

At present, IAREO are mainly mined by in-situ leaching processes, for example with ammonium sulfate and magnesium sulfate. The mining is essentially an ion exchange reaction between leaching agent cations and hydrated rare earth ions or hydroxyl hydrated rare earth ions adsorbed onto clay minerals. However, the ion exchange reaction could only realize a leaching of the ion-exchangeable phase rare earths, and shows an extremely poor leaching effect on the colloidal sediment phase rare earths and mineral phase rare earths, thus causing serious waste of rare earth resources.

In order to improve the rare earth leaching efficiency, techniques such as magnetic field, external electric field, and ultrasonic wave are used during the leaching from IAREO. However, such methods are generally difficult to apply in practical engineering due to environmental constraints. In addition, leaching assistants such as fulvic acid and humic acid are also used for enhancing the leaching from the IAREO. For example, Chinese patent publication CN105274362A discloses a method for intensified-reduction leaching of a rare earth in an IAREO. Ascorbic acid and a solution containing ferrous ions are mixed to prepare a leaching agent, and the leaching of colloidal sediment phase rare earths is realized through composite reduction of the ascorbic acid and ferrous ions. Chinese patent publication CN114703365A discloses a compound leaching agent for a weathered crust elution-deposited rare earth ore (WCE-DREO). Humic acid is added into a traditional leaching agent ammonium sulfate to form a compound leaching agent, which is injected into an ore body to leach the IAREO. Chinese patent publication CN103255301A discloses a leaching method of a WCE-DREO, in which a leaching agent is used and fulvic acid is used as a leaching assistant. The leaching agent is potassium chloride, sodium chloride, ammonium sulfate, or magnesium chloride. However, these methods could only enhance the leaching of ion-exchangeable phase rare earths, and result in a poor leaching efficiency of colloidal sediment phase rare earths and mineral phase rare earths, thus still causing a serious waste of rare earth resources.

### SUMMARY

In view of this, an object of the present disclosure is to provide use of an organic acid-containing leaching agent in leaching rare earth elements from an ion-adsorption type rare earth ore (IAREO) and a method for leaching full-phase rare earth. In the present disclosure, the organic acid-containing leaching agent could realize comprehensive enhanced leaching of the ion-exchangeable phase rare earth, colloidal sediment phase rare earth, and mineral phase rare earth in the IAREO. It results in a high rare earth leaching efficiency and a low dosage of the leaching agent, and avoids the resource waste of colloidal sediment phase rare earths and mineral phase rare earths and the excessive use of leaching agent in traditional rare earth leaching methods.

To achieve the above object, the present disclosure provides the following technical solutions:

The present disclosure provides use of an organic acid-containing leaching agent in leaching rare earth from an IAREO, wherein the organic acid-containing leaching agent comprises an organic acid leaching agent or an organic acid-chemical compound leaching agent, and a solvent in the organic acid-containing leaching agent is water;
an organic acid in the organic acid-containing leaching agent comprises one or more selected from the group consisting of ascorbic acid, gluconic acid, lactobionic acid, malic acid, citric acid, isobutyric acid, formic acid, and glyoxylic acid; and
a molar ratio of the organic acid to a chemical agent in the organic acid-chemical compound leaching agent is in a range of 1:(0.10-12); and the chemical agent in the organic acid-chemical compound leaching agent comprises one or more selected from the group consisting of a water-soluble ammonium salt, a water-soluble magnesium salt, a water-soluble potassium salt, a water-soluble sodium salt, a water-soluble calcium salt, a water-soluble ferric salt, and a water-soluble ferrous salt.

In some embodiments, a total concentration of the organic acid in the organic acid leaching agent is in a range of 0.005 mol/L to 2 mol/L; and
the organic acid leaching agent has a pH value of 1 to 6.5.

In some embodiments, the organic acid in the organic acid leaching agent comprises at least two selected from the group consisting of ascorbic acid, gluconic acid, lactobionic acid, malic acid, citric acid, isobutyric acid, formic acid, and glyoxylic acid.

In some embodiments, a total concentration of cations in the organic acid-chemical compound leaching agent is in a range of 0.005 mol/L to 2 mol/L; and
the organic acid-chemical compound leaching agent has a pH value of 1 to 7.5.

In some embodiments, the water-soluble ammonium salt includes one or more selected from the group consisting of ammonium sulfate, ammonium chloride, and ammonium nitrate;
the water-soluble magnesium salt includes one or more selected from the group consisting of magnesium sulfate, magnesium chloride, and magnesium nitrate;
the water-soluble potassium salt includes one or more selected from the group consisting of potassium chloride, potassium sulfate, and potassium nitrate;
the water-soluble sodium salt includes one or more selected from the group consisting of sodium chloride, sodium sulfate, and sodium nitrate;
the water-soluble calcium salt includes calcium chloride;
the water-soluble ferric salt includes ferric chloride; and
the water-soluble ferrous salt includes at least one of ferrous chloride and ferrous sulfate.

The present disclosure further provides a method for leaching full-phase rare earth from an ion-adsorption type rare earth ore (IAREO), including the following steps:
conducting rare earth leaching on the IAREO by using the organic acid-containing leaching agent as described in above technical solutions, to obtain a rare earth leaching liquor.

In some embodiments, a rare earth element in the IAREO includes one or more selected from the group consisting of lanthanum, cerium, praseodymium, neodymium, promethium, samarium, europium, gadolinium, terbium, dysprosium, holmium, erbium, thulium, ytterbium, lutetium, yttrium, and scandium.

In some embodiments, a solid-to-liquid ratio of the IAREO to the organic acid-containing leaching agent is in a range of 1 g:(1-12) mL.

In some embodiments, the rare earth leaching includes column leaching, in-situ ore leaching, heap leaching, or pool leaching.

In some embodiments, the organic acid-containing leaching agent during the column leaching has a flow rate of 0.05 mL/min to 5 mL/min; and
the in-situ ore leaching, the heap leaching, and the pool leaching are each independently conducted for 4 h to 24 h.

In the present disclosure, when the organic acid leaching agent is used to leach a rare earth in the IAREO, anions dissociated from the organic acid complexes with leached rare earth ions, which suppresses the re-adsorption of rare earth ions onto the clay minerals, thereby improving a leaching efficiency of the rare earth. Meanwhile, the dissolution and leaching of the colloidal sediment phase rare earth and the mineral phase rare earth is realized using organic acid anions with a reducing effect and H⁺ dissociated from the organic acid, in which, ion-exchangeable phase rare earths are leached out by means of ion exchange, thereby improving the leaching efficiency of full-phase rare earths in IAREO. When multiple organic acids are compounded, the organic acid anions can realize the dissociation of organically complexed rare earth ions through the complexation competition of a multi-component system, so as to further release the colloidal sediment phase and mineral phase rare earths. This results in stronger leaching capacity and complexing capacity for IAREOs, and realizes the comprehensive and enhanced leaching of full-phase rare earths in the IAREOs. As a result, while increasing a rare earth leaching efficiency, the dosage of leaching agent is reduced. Therefore, the resource waste of colloidal sediment phase rare earths and mineral phase rare earths in traditional rare earth leaching methods is avoided, thereby saving rare earth resources. After leaching the rare earths in IAREO, the organic acids remaining in mine soil can be decomposed by indigenous microorganisms to achieve rapid ecological restoration of the mine after mining, which avoids or alleviates the ecological damage caused by leaching rare earths with traditional chemical leaching agents, thereby achieving the green, efficient, and eco-friendly leaching from IAREO resources.

In the present disclosure, when the organic acid-chemical compound leaching agent is used to leach the rare earth in the IAREO, the rare earth ions adsorbed on the clay minerals are replaced with H⁺ dissociated from the organic acid and the cations of the chemical leaching agent. The exchanged rare earth ions are complexed with organic acid anions to inhibit the re-adsorption of rare earth ions onto the clay minerals, thereby increasing the leaching efficiency of rare earths and reducing the dosage of leaching agent. Moreover, on this basis, due to acidity and reducing properties, the organic acid can dissolve and leach colloidal sediment phase rare earths and mineral phase rare earths. When multiple organic acids are compounded, the organic acid anions can realize the dissociation of organically complexed rare earth ions through the complexation competition of a multi-component system, so as to further release the colloidal sediment phase and mineral phase rare earths. This results in stronger leaching capacity and complexing capacity for IAREOs, and realizes the comprehensive and enhanced leaching of full-phase rare earths in the IAREOs. As a result, while increasing a rare earth leaching efficiency, the dosage of leaching agent is reduced. Therefore, the resource waste of colloidal sediment phase rare earths and mineral phase rare earths in the traditional rare earth leaching methods is avoided, thereby saving rare earth resources. Furthermore, the organic acid can form a ligand complex with cations in the chemical leaching agent, thereby reducing saturation of the cations in a solution and promoting a forward progress of the rare earth leaching. The method simultaneously can realize the enhanced leaching of ion-exchangeable phase, colloidal sediment phase, and mineral phase rare earths, and achieve a higher rare earth leaching efficiency while reducing the dosage of leaching agent. Accordingly, a leaching mechanism of the organic acid to IAREOs can increase a yield of the IAREOs and reduce the waste of rare earth resources during the use in ore leaching. In addition, a type of the chemical leaching agent in the organic acid-chemical compound leaching agent can be selected according to IAREO soil conditions and element contents in the use site. For example, with water-soluble magnesium salts, water-soluble calcium salts, and water-soluble potassium salts, soil nutrients can be replenished during ore leaching, thereby improving the soil nutrients in a mining area.

### DETAILED DESCRIPTION OF THE EMBODIMENTS

The present disclosure provides use of an organic acid-containing leaching agent in leaching from an IAREO, wherein the organic acid-containing leaching agent comprises an organic acid leaching agent or an organic acid-chemical compound leaching agent, and a solvent in the organic acid-containing leaching agent is water;
an organic acid in the organic acid-containing leaching agent includes one or more selected from the group consisting of ascorbic acid, gluconic acid, lactobionic acid, malic acid, citric acid, isobutyric acid, formic acid, and glyoxylic acid;
a molar ratio of the organic acid to a chemical agent in the organic acid-chemical compound leaching agent is in a range of 1:(0.10-12); and the chemical agent in the organic acid-chemical compound leaching agent includes one or more selected from the group consisting of a water-soluble ammonium salt, a water-soluble magnesium salt, a water-soluble potassium salt, a water-soluble sodium salt, a water-soluble calcium salt, a water-soluble ferric salt, and a water-soluble ferrous salt.

Unless otherwise specified, the raw materials used in the present disclosure are all commercially available commodities.

In some embodiments of the present disclosure, the organic acid in the organic acid leaching agent includes at least two selected from the group consisting of ascorbic acid, gluconic acid, lactobionic acid, malic acid, citric acid, isobutyric acid, formic acid, and glyoxylic acid. In some embodiments, the organic acid in the organic acid leaching agent includes malic acid, malic acid-ascorbic acid, malic acid-gluconic acid, ascorbic acid-citric acid, ascorbic acid-formic acid, or ascorbic acid-formic acid-glyoxylic acid. In some embodiments, a molar ratio of the malic acid to the ascorbic acid in the malic acid-ascorbic acid is 8:1. In some embodiments, a molar ratio of the malic acid to the gluconic acid in the malic acid-gluconic acid is 5:1. In some embodiments, a molar ratio of the ascorbic acid to the citric acid in the ascorbic acid-citric acid is 1:4. In some embodiments, a molar ratio of the ascorbic acid to the formic acid in the ascorbic acid-formic acid is 5:1. In some embodiments, a molar ratio of the ascorbic acid, the formic acid, and the glyoxylic acid in the ascorbic acid-formic acid-glyoxylic acid is 1:4:3. In some embodiments, a total concentration of the organic acid in the organic acid leaching agent is in a range of 0.005 mol/L to 2 mol/L, and preferably 0.1 mol/L to 1 mol/L. In some embodiments, the organic acid leaching agent has a pH value of 1 to 6.5, and preferably 1.5 to 4.

In some embodiments of the present disclosure, a total concentration of the organic acid and the chemical agent in the organic acid-chemical compound leaching agent is in a range of 0.005 mol/L to 2 mol/L, and preferably 0.1 mol/L to 0.15 mol/L. the concentration of the chemical leaching agent being in terms of cations.

In some embodiments of the present disclosure, a total concentration of cations (hydrogen ions, ammonium ions, magnesium ions, potassium ions, sodium ions, calcium ions, ferric ions, and ferrous ions) in the organic acid-chemical compound leaching agent is in a range of 0.01 mol/L to 2 mol/L, and preferably 0.1 mol/L to 0.5 mol/L. In some embodiments, the organic acid-chemical compound leaching agent has a pH value of 1 to 7.5, preferably 2 to 5.5, and specifically preferably 2, 2.5, 3, 3.5, 4, 4.5, 5, or 5.5.

In some embodiments of the present disclosure, when a pH value of the organic acid-containing leaching agent does not meet the above requirements, the pH value is adjusted with an inorganic acid or an inorganic alkali. In some embodiments, the inorganic acid includes one or more of hydrochloric acid, nitric acid, and sulfuric acid. In some embodiments, the inorganic alkali includes one or more of potassium hydroxide, calcium hydroxide, and sodium hydroxide.

In some embodiments of the present disclosure, the water-soluble ammonium salt includes one or more of ammonium sulfate, ammonium chloride, and ammonium nitrate. In some embodiments, the water-soluble magnesium salt includes one or more of magnesium sulfate, magnesium chloride, and magnesium nitrate. In some embodiments, the water-soluble potassium salt includes one or more of potassium chloride, potassium sulfate, and potassium nitrate. In some embodiments, the water-soluble sodium salt includes one or more of sodium chloride, sodium sulfate, and sodium nitrate. In some embodiments, the water-soluble calcium salt includes calcium chloride. In some embodiments, the water-soluble ferric salt includes ferric chloride. In some embodiments, the water-soluble ferrous salt includes ferrous chloride and/or ferrous sulfate.

In some embodiments of the present disclosure, a molar ratio of the organic acid to the chemical agent in the organic acid-chemical compound leaching agent is in a range of 1:(0.10-12), preferably 1:(0.15-11), and further preferably 1:(1-10). In some embodiments of the present disclosure, an organic acid-chemical leaching agent combination in the organic acid-chemical compound leaching agent includes ascorbic acid-magnesium sulfate combination, gluconic acid-magnesium sulfate combination, lactobionic acid-magnesium sulfate combination, malic acid-magnesium sulfate combination, citric acid-magnesium sulfate combination, isobutyric acid-magnesium sulfate combination, formic acid-magnesium sulfate combination, glyoxylic acid-magnesium sulfate combination, ascorbic acid-citric acid-magnesium sulfate combination, ascorbic acid-citric acid-magnesium chloride combination, ascorbic acid-citric acid-ammonium sulfate combination, ascorbic acid-citric acid-calcium chloride combination, ascorbic acid-citric acid-ferric chloride combination, ascorbic acid-citric acid-ferrous chloride combination, ascorbic acid-citric acid-magnesium sulfate-ferrous chloride combination, ascorbic acid-citric acid-magnesium sulfate-calcium chloride-ferrous chloride combination, ascorbic acid-magnesium sulfate-ferrous chloride combination, ascorbic acid-magnesium chloride-calcium chloride-ferrous chloride combination, citric acid-ammonium sulfate-magnesium sulfate-ferric chloride combination, or ascorbic acid-citric acid-gluconic acid-magnesium sulfate-calcium chloride-ferrous chloride combination. In some embodiments, a molar ratio of the ascorbic acid to the magnesium sulfate in the ascorbic acid-magnesium sulfate combination is 1:9. In some embodiments, a molar ratio of the gluconic acid to the magnesium sulfate in the gluconic acid-magnesium sulfate combination is 1:9. In some embodiments, a molar ratio of the lactobionic acid to the magnesium sulfate in the lactobionic acid-magnesium sulfate combination is 1:8. In some embodiments, a molar ratio of the malic acid to the magnesium sulfate in the malic acid-magnesium sulfate combination is 1:8. In some embodiments, a molar ratio of the citric acid to the magnesium sulfate in the citric acid-magnesium sulfate combination is 1:5. In some embodiments, a molar ratio of the isobutyric acid to the magnesium sulfate in the isobutyric acid-magnesium sulfate combination is 1:1. In some embodiments, a molar ratio of the formic acid to the magnesium sulfate in the formic acid-magnesium sulfate combination is 1:1. In some embodiments, a molar ratio of the glyoxylic acid to the magnesium sulfate in the glyoxylic acid-magnesium sulfate combination is 1:3. In some embodiments, a molar ratio of the ascorbic acid, the citric acid, and the magnesium sulfate in the ascorbic acid-citric acid-magnesium sulfate combination is 1:3:5. In some embodiments, a molar ratio of the ascorbic acid, the citric acid, and the magnesium chloride in the ascorbic acid-citric acid-magnesium chloride combination is 2:1:5. In some embodiments, a molar ratio of the ascorbic acid, the citric acid, and the ammonium sulfate in the ascorbic acid-citric acid-ammonium sulfate combination is 1:3:5. In some embodiments, a molar ratio of the ascorbic acid, the citric acid, and the calcium chloride in the ascorbic acid-citric acid-calcium chloride combination is 1:3:2. In some embodiments, a molar ratio of the ascorbic acid, the citric acid, and the ferric chloride in the ascorbic acid-citric acid-ferric chloride combination is 1:5:1. In some embodiments, a molar ratio of the ascorbic acid, the citric acid, and the ferrous chloride in the ascorbic acid-citric acid-ferrous chloride combination is 1:5:1. In some embodiments, a molar ratio of the ascorbic acid, the citric acid, the magnesium sulfate, and the ferrous chloride in the ascorbic acid-citric acid-magnesium sulfate-ferrous chloride combination is 1:3:5:1. In some embodiments, a molar ratio of the ascorbic acid, the citric acid, the magnesium sulfate, the calcium chloride, and the ferrous chloride in the ascorbic acid-citric acid-magnesium sulfate-calcium chloride-ferrous chloride combination is 1:3:5:0.5:0.5. In some embodiments, a molar ratio of the ascorbic acid, the magnesium sulfate, and the ferrous chloride in the ascorbic acid-magnesium sulfate-ferrous chloride combination is 1:8:1. In some embodiments, a molar ratio of the ascorbic acid, the magnesium chloride, the calcium chloride, and the ferrous chloride in the ascorbic acid-magnesium chloride-calcium chloride-ferrous chloride combination is 1:8:1:1. In some embodiments, a molar ratio of the citric acid, the ammonium sulfate, the magnesium sulfate, and the ferric chloride in the citric acid-ammonium sulfate-magnesium sulfate-ferric chloride combination is 3:1:5:1. In some embodiments, a molar ratio of the ascorbic acid, the citric acid, the gluconic acid, the magnesium sulfate, the calcium chloride, and the ferrous chloride in the ascorbic acid-citric acid-gluconic acid-magnesium sulfate-calcium chloride-ferrous chloride combination is 1:3:2:6:1:1.

The present disclosure further provides a method for leaching full-phase rare earth from an IAREO, including the following steps: conducting rare earth leaching on the IAREO by using the organic acid-containing leaching agent as defined in the use as described in above technical solutions, to obtain a rare earth leaching liquor.

In some embodiments of the present disclosure, a rare earth element in the IAREO includes one or more of lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), yttrium (Y), and scandium (Sc). In some embodiments, when the rare earth leaching is performed by column leaching, the IAREO is sieved before use. There is no special limitation on a means for the sieving, as long as the IAREO with a particle size of less than 2 mm can be obtained.

In some embodiments of the present disclosure, a solid-to-liquid ratio of the IAREO to the organic acid-containing leaching agent is in a range of 1 g:(1-12) mL, and preferably 1 g:(1-10) mL, specifically preferably 1 g: 1 mL, 1 g: 2 mL, 1 g: 3 mL, 1 g: 4 mL, 1 g: 5 mL, 1 g: 6 mL, 1 g: 7 mL, 1 g: 8 mL, 1 g: 9 mL, or 1 g: 10 mL.

In some embodiments of the present disclosure, the leaching includes column leaching, in-situ ore leaching, heap leaching, or pool leaching. In some embodiments of the present disclosure, the in-situ ore leaching is conducted at a temperature the same as that of an environment where the IAREO is located. In some embodiments, the column leaching, the heap leaching, and the pool leaching are each conducted at room temperature (25° C.). In some embodiments, the column leaching, the heap leaching, and the pool leaching are each independently conducted for 4 h to 24 h, and preferably 5 h to 12 h. In some embodiments, the organic acid-containing leaching agent during the column leaching has a flow rate of 0.05 mL/min to 5 mL/min, and preferably 0.1 mL/min to 2 mL/min.

In the method for leaching full-phase rare earth from an IAREO according to the present disclosure, in the used organic acid-containing leaching agent, the H⁺ dissociated from the organic acid and the cations of the chemical leaching agent undergo ion exchange with the ion-exchangeable phase rare earth adsorbed on the clay minerals, such that the rare earth ions are exchanged from the clay minerals and then introduced into the leaching agent. Organic acid anions and rare earth cations undergo complexation, thereby inhibiting the re-adsorption of rare earth ions onto the clay minerals, so as to decrease the dosage of leaching agent and increase the leaching efficiency of ion-exchangeable phase rare earths. The organic acid can reduce a pH value in the solution, and dissolve the rare earth elements from hydroxides, oxides, carbonates, or other minerals through proton exchange (except for acid-insoluble hydroxides such as Ce(OH)₄). When the pH value of the solution is less than 3, the proton interaction can strongly promote the separation of metal elements from the mineral. In addition, organic acid anions could realize the dissociation of organically-complexed rare earth ions through the complexation competition of a multi-component system, and further release rare earths in colloidal sediment phase and mineral phase. Moreover, the organic acid could form a ligand complex with metal elements, thereby reducing saturation of the metal elements in a solution and promoting a forward progress of the rare earth leaching. The organic acid having a reducing effect could also reduce insoluble rare earths represented by 4-valent Ce into easily-soluble Ce element such as 3-valent and other rare earth elements, to further strengthen the mining of rare earths. The method could simultaneously realize the enhanced leaching of ion-exchangeable phase, colloidal sediment phase, and mineral phase rare earths, and achieve a higher rare earth leaching efficiency while reducing the dosage of leaching agent. Accordingly, a leaching mechanism of the organic acid to IAREOs could increase a yield of the IAREOs and reduce the waste of rare earth resources during the use in ore leaching. The organic acids residues in the soil could be utilized by other microorganisms to strengthen the ecological diversity of soil microorganisms in the mining area and reconstruct soil aggregates, and avoid the soil and groundwater pollution in the mining area. The method for leaching full-phase rare earth from an IAREO can realize comprehensive enhanced leaching of ion-exchangeable phase rare earths, colloidal sediment phase rare earths, and mineral phase rare earths. The method allows for increasing the rare earth leaching efficiency, while reducing the dosage of leaching agent, and finally realizing the saving of rare earth resources.

The technical solutions of the present disclosure will be clearly and completely described below with reference to the examples of the present disclosure. Apparently, the described examples are merely a part rather than all of the examples of the present disclosure. All other examples obtained by a person of ordinary skill in the art based on the examples of the present disclosure without creative efforts shall fall within the scope of the present disclosure.

A raw ore used in the following examples and comparative examples was an IAREO. A chemical composition and full-phase rare earth element partition of the IAREO used were calculated by using X-ray fluorescence (XRF) analysis and rare earth element partition. The chemical composition is shown in Table 1, and the full-phase rare earth element partition is shown in Table 2:

TABLE 1
Chemical composition of the IAREO

| Elements | Al₂O₃ | SiO₂ | K₂O | TiO₂ | Fe₂O₃ | Nd₂O₃ | PbO | MgO |
|---|---|---|---|---|---|---|---|---|
| Content/wt % | 36.600 | 52.900 | 5.600 | 0.190 | 4.180 | 0.112 | 0.043 | 0.024 |

TABLE 2
Full-phase rare earth element partition of the IAREO

| Rare earth oxides | La₂O₃ | CeO₂ | Pr₆O₁₁ | Nd₂O₃ | Sm₂O₃ | Eu₂O₃ | Gd₂O₃ | Tb₄O₇ |
|---|---|---|---|---|---|---|---|---|
| Content/wt % | 24.07 | 38.63 | 6.270 | 23.34 | 4.369 | 0.07 | 3.66 | 0.06 |

| Rare earth oxides | Dy₂O₃ | Ho₂O₃ | Er₂O₃ | Y₂O₃ | Yb₂O₃ | Lu₂O₃ | Tm₂O₃ |
|---|---|---|---|---|---|---|---|
| Content/wt % | 2.56 | 0.42 | 0.88 | 12.71 | 0.06 | — | — |

The symbol “—” in Table 2 refers to “not detected”.

The rare earth leaching liquor was tested by an inductively coupled plasma-optical emission spectrometer (ICP-OES), and a leaching efficiency was calculated. The testing process was as follows:

A prepared rare earth leaching liquor containing rare earth elements was tested by the ICP-OES, and a full-phase rare earth leaching efficiency was calculated according to Equation 1:

$$η = \frac{{m}_{1}}{{m}_{2}} \times 100 \% , \qquad Equation 1$$

where
in Equation 1, η represents a full-phase rare earth leaching efficiency; m₁ represents a total rare earth content in the leaching liquor; and m₂ represents a full-phase rare earth content in a raw ore.

The total rare earth content in the rare earth leaching liquor was calculated according to Equation 2:

$${m}_{1} \frac{{c}_{1} \times V \times n}{M} , \qquad Equation 2$$

where
in Equation 2, m₁ represents a total rare earth content in the leaching liquor; c₁ represents a total rare earth ion concentration tested by ICP-OES; V represents a total volume of a diluent in on-machine test; n represents a dilution factor; and M represents a total mass of the raw ore.

The ion-exchangeable phase rare earth leaching efficiency was calculated according to Equation 3:

$${η}_{ion} = ( 1 - \frac{{c}_{residual ion} \times V \times n}{M \times {m}_{ion}} ) \times 100 \% , \qquad Equation 3$$

where
in Equation 3, ηᵢₒₙ represents the ion-exchangeable phase rare earth leaching efficiency; c_{residual ion} represents a total rare earth ion concentration of a residual ion-exchangeable phase leaching liquor; V represents a total volume of a diluent in on-machine test; n represents a dilution factor; M represents a total mass of the raw ore; and mᵢₒₙ represents an ion-exchangeable phase rare earth content of the raw ore.

The content of ion-exchangeable phase rare earth was measured with reference to the determination for a total content of ion-exchangeable phase rare earth in a chemical analysis method of the ion-exchangeable rare earth raw ore in XB/T 619-2015, China.

The colloidal sediment phase rare earth leaching efficiency was calculated according to Equation 4:

$${η}_{colloid} = ( 1 - \frac{{c}_{residual colloid} \times V \times n}{M \times {m}_{colloid}} ) \times 100 \% , \qquad Equation 4$$

where
in Equation 4, η_{colloid} represents the colloidal sediment phase rare earth leaching efficiency; c_{residual colloid} represents a total rare earth ion concentration in the residual colloidal sediment phase leaching liquor; V represents a total volume of a diluent in on-machine test; n represents a dilution factor; M represents a total mass of the raw ore; and m_{colloid} represents a mass percentage of colloidal sediment phase rare earth in the raw ore.

A method for measuring the content of colloidal sediment phase rare earth was as follows: extracting the colloidal sediment phase rare earth with a 2 mol/L HCl-0.5 mol/L hydroxylamine hydrochloride solution at a solid-to-liquid ratio of 1:6 (g:mL), diluting to a certain volume and then undergoing on-machine test.

The mineral phase rare earth leaching efficiency was calculated according to Equation 5:

$${η}_{mine} = ( 1 - \frac{{c}_{residual mine} \times V}{{M}_{mine} \times {m}_{mine}} ) \times 100 \% , \qquad Equation 5$$

where
in Equation 5, ηₘᵢₙₑ represents the mineral phase rare earth leaching efficiency; c_{residual mine} represents a total rare earth ion concentration in a residual mineral phase digestion solution after the rare earth tailings obtained after extracting the colloidal sediment phase rare earth are digested; V represents a total volume of a diluent in on-machine test; Mₘᵢₙₑ represents a digested total mass of rare earth tailings obtained after extracting the colloidal sediment phase rare earth; and mₘᵢₙₑ represents a mineral phase rare earth content of the raw ore.

A method for measuring the content of mineral phase rare earth was as follows: adding 10 mL of 50% aqua regia into about 0.1 g of dried tailings obtained from extracting the colloidal sediment phase rare earth, digesting by microwave digestion, filtering, diluting a filtrate with 1% HNO₃ obtained to a certain volume, and undergoing on-machine test.

Test conditions: a test instrument Jena PQ9000 ICP-OES was used, with spectral line each selected for rare earth elements shown in Table 3.

TABLE 3
Selection results of each spectral line of rare earth elements

| Elements | La | Ce | Pr | Nd | Sm | Eu | Gd | Y |
|---|---|---|---|---|---|---|---|---|
| Wavelength/nm | 333.749 | 418.660 | 422.293 | 406.109 | 356.827 | 381.967 | 342.247 | 371.030 |

| Elements | Tb | Dy | Ho | Er | Tm | Yb | Lu |
|---|---|---|---|---|---|---|---|
| Wavelength/nm | 350.917 | 353.107 | 345.600 | 369.265 | 313.126 | 369.419 | 291.139 |

### Example 1

100 g of a dry IAREO with a particle size of less than 2 mm was subjected to column leaching at room temperature (25° C.) with an organic acid-containing leaching agent (pH=3.0) at an injection rate of 0.3 m/min. After eluting with the organic acid-containing leaching agent, pure water was added for elution, and all effluents were collected as a rare earth leaching liquor for testing a leaching efficiency of all rare earths. The organic acid-containing leaching agent was an aqueous solution of ascorbic acid-magnesium sulfate with a total concentration (a sum of the concentration of ascorbic acid and the concentration of magnesium sulfate) of 0.1 mol/L, in which a molar ratio of the ascorbic acid to the magnesium sulfate was 1:9, and the pH value of the organic acid-containing leaching agent was achieved by adjusting with sulfuric acid and sodium hydroxide. A solid-to-liquid ratio of the IAREO (dry weight) to the organic acid-containing leaching agent was 1:4 (g:mL). A solid-to-liquid ratio of the pure water to the IAREO was 1 g: 1 mL. The rare earth leaching liquor was tested by ICP-OES to obtain a concentration of each rare earth element.

The residual ion-exchangeable phase rare earth was leached using ammonium sulfate solution with a concentration of 0.38 mol/L, and purified water was then added for elution. All the effluents were collected for testing the residual ion-exchangeable phase rare earth. The leaching efficiency of the ion-exchangeable phase rare earth was calculated. The solid-liquid ratio of the IAREO to the ammonium sulfate solution was 1 g: 6 mL, and the solid-to-liquid ratio of the IAREO to the pure water was 1 g: 1 mL. During the process, the ammonium sulfate solution and water were added at an injection rate of 0.3 mL/min.

The residual colloidal sediment phase rare earth was leached using an acidic hydroxylamine hydrochloride solution (2 mol/L HCl and 0.5 mol/L hydroxylamine hydrochloride), and pure water was then added for elution. All the effluents were collected for testing the residual colloidal sediment phase rare earth. The leaching efficiency of the colloidal sediment phase rare earth was calculated. The solid-liquid ratio of the IAREO to the acidic hydroxylamine hydrochloride solution was 1 g: 6 mL, and the solid-to-liquid ratio of the IAREO to the pure water was 1 g: 1 mL. During the process, the acidic hydroxylamine hydrochloride solution was added at an injection rate of 0.3 mL/min.

The rare earth tailings were taken out, dried, ground, and digested with aqua regia, and a resulting digestion solution was used to test the residual mineral phase rare earth and calculate the leaching efficiency of mineral phase rare earth.

Rare earth parameters in terms of IAREO full-phase, ion-exchangeable phase, colloidal sediment phase, and mineral phase, as well as the rare earth leaching efficiency in terms of full-phase, ion-exchangeable phase, colloidal sediment phase, and mineral phase are shown in Table 5.

### Examples 2 to 26

The leaching of rare earth was conducted according to the method of Example 1, and leaching efficiency was calculated. In Examples 2 to 26, the rare earth leaching conditions are shown in Table 4, and the leaching results are shown in Table 5. The pH value was adjusted with sulfuric acid and sodium hydroxide.

### Comparative Examples 1 to 8

The leaching of rare earth was conducted according to the method of Example 1, and leaching efficiency was calculated. In Comparative Examples 1 to 8, the rare earth leaching conditions are shown in Table 4, and the leaching results are shown in Table 5. In Comparative Example 3 and Comparative Example 6 the leaching agent disclosed in CN105274362A (incorporated by reference) was used; in Comparative Example 4 and Comparative Example 7 the leaching agent disclosed in CN114703365A (incorporated by reference) was used; in Comparative Example 5 and Comparative Example 8 the leaching agent disclosed in CN103255301A (incorporated by reference) was used. Specifically, in Comparative Example 6 the compound leaching agent disclosed in Example 5 of CN105274362A (incorporated by reference) was used; in Comparative Example 7 the compound leaching agent disclosed in Example 7 of CN114703365A (incorporated by reference) was used; in Comparative Example 8 the compound leaching agent disclosed in Example 8 of CN103255301A (incorporated by reference) was used.

TABLE 4
Leaching conditions of Examples 1 to 26 and Comparative Examples 1 to 8 (organic
acid-containing leaching agent, injection rate, and solid-to-liquid ratio)

| | Organic acid-containing leaching agent | | | | Solid- |
|---|---|---|---|---|---|
| | | Total | | Injection | to- |
| | Leaching agent type | concentration/ | | rate | liquid |
| | and molar ratios | mol/L | pH | (mL/min) | ratio |
| Example 1 | Ascorbic acid:magnesium sulfate = 1:9 | 0.1 | 3.0 | 0.3 | 1:4 |
| Example 2 | Gluconic acid:magnesium sulfate = 1:9 | 0.1 | 3.5 | 0.4 | 1:4 |
| Example 3 | Lactobionic acid:magnesium sulfate = 1:8 | 0.15 | 3.0 | 0.2 | 1:4 |
| Example 4 | Malic acid:magnesium sulfate = 1:8 | 0.15 | 3.0 | 0.1 | 1:6 |
| Example 5 | Citric acid:magnesium sulfate = 1:5 | 0.2 | 2.0 | 0.2 | 1:3 |
| Example 6 | Isobutyric acid:magnesium sulfate = 1:1 | 0.05 | 2.5 | 0.3 | 1:5 |
| Example 7 | Formic acid:magnesium sulfate = 1:1 | 0.02 | 3.0 | 0.3 | 1:10 |
| Example 8 | Glyoxylic acid:magnesium sulfate = 1:3 | 0.2 | 2.0 | 0.5 | 1:1 |
| Example 9 | Malic acid | 0.15 | 1.5 | 1 | 1:3 |
| Example 10 | Malic acid:ascorbic acid = 8:1 | 0.15 | 1.5 | 2 | 1:3 |
| Example 11 | Malic acid:gluconic acid = 5:1 | 0.15 | 1.5 | 2 | 1:5 |
| Example 12 | Ascorbic acid:citric acid = 1:4 | 0.12 | 1.5 | 0.5 | 1:5 |
| Example 13 | Ascorbic acid:formic acid = 5:1 | 0.12 | 1.5 | 0.5 | 1:5 |
| Example 14 | Ascorbic acid:formic acid:glyoxylic | 0.12 | 1.5 | 0.8 | 1:5 |
| | acid = 1:4:3 | | | | |
| Example 15 | Ascorbic acid:citric acid:magnesium | 0.18 | 2.5 | 0.3 | 1:4 |
| | sulfate = 1:3:5 | | | | |
| Example 16 | Ascorbic acid:citric acid:magnesium | 0.12 | 2.5 | 0.3 | 1:4 |
| | chloride = 2:1:5 | | | | |
| Example 17 | Ascorbic acid:citric acid:ammonium | 0.18 | 2.5 | 0.5 | 1:4 |
| | sulfate = 1:3:5 | | | | |
| Example 18 | Ascorbic acid:citric acid:calcium | 0.15 | 2.0 | 1 | 1:4 |
| | chloride = 1:3:2 | | | | |
| Example 19 | Ascorbic acid:citric acid:ferric | 0.12 | 2.0 | 0.5 | 1:4 |
| | chloride = 1:5:1 | | | | |
| Example 20 | Ascorbic acid:citric acid:ferrous | 0.12 | 2.0 | 1 | 1:4 |
| | chloride = 1:5:1 | | | | |
| Example 21 | Ascorbic acid:citric acid:magnesium | 0.1 | 2.0 | 1.5 | 1:4 |
| | sulfate:ferrous chloride = 1:3:5:1 | | | | |
| Example 22 | Ascorbic acid:citric acid:magnesium | 0.1 | 2.0 | 0.8 | 1:5 |
| | sulfate:calcium chloride:ferrous | | | | |
| | chloride = 1:3:5:0.5:0.5 | | | | |
| Example 23 | Ascorbic acid:magnesium | 0.12 | 3.0 | 0.3 | 1:5 |
| | sulfate:ferrous chloride = 1:8:1 | | | | |
| Example 24 | Ascorbic acid:magnesium | 0.12 | 3.0 | 0.5 | 1:5 |
| | chloride:calcium chloride:ferrous | | | | |
| | chloride = 1:8:1:1 | | | | |
| Example 25 | Citric acid:ammonium | 0.1 | 3.0 | 0.5 | 1:5 |
| | sulfate:magnesium sulfate:ferric | | | | |
| | chloride = 3:1:5:1 | | | | |
| Example 26 | Ascorbic acid:citric acid:gluconic | 0.12 | 3.0 | 0.8 | 1:5 |
| | acid:magnesium sulfate:calcium | | | | |
| | chloride:ferrous chloride = 1:3:2:6:1:1 | | | | |
| Comparative | Ammonium sulfate | 0.1 | 4.5 | 0.3 | 1:4 |
| Example 1 | | | | | |
| Comparative | Magnesium sulfate | 0.1 | 4.5 | 0.3 | 1:4 |
| Example 2 | | | | | |
| Comparative | Ascorbic acid:magnesium | 0.1 | 3.0 | 0.3 | 1:4 |
| Example 3 | sulfate:ferrous sulfate = 1:4:1 | | | | |
| Comparative | Humic acid:magnesium sulfate = 1:19 | 0.1 | 5.5 | 0.3 | 1:4 |
| Example 4 | | | | | |
| Comparative | Fulvic acid:magnesium sulfate = 1:9 | 0.1 | 5.5 | 0.3 | 1:4 |
| Example 5 | | | | | |
| Comparative | Ascorbic acid:ammonium sulfate:ferrous | 0.71 | 2.0 | 0.3 | 1:5 |
| Example 6 | sulfate:potassium chloride = 1:30:20:20 | | | | |
| Comparative | Humic acid:ammonium sulfate = 1:20 | 0.105 | 5.5 | 0.3 | 2:1 |
| Example 7 | | | | | |
| Comparative | Fulvic acid:ammonium sulfate = 1:75 | 0.23 | 5.5 | 0.3 | 5:2 |
| Example 8 | | | | | |

TABLE 5
Rare earth parameters in terms of IAREO full-phase, ion-exchangeable phase, colloidal sediment phase,
and mineral phase, as well as rare earth leaching efficiency in terms of full-phase, ion-exchangeable
phase, colloidal sediment phase, and mineral phase in Examples 1 to 26 and Comparative Examples 1 to 8

| | IAREO full-phase | | | | Leaching effect | | | |
|---|---|---|---|---|---|---|---|---|
| | | | Colloidal | | | | Colloidal | |
| | | Ion- | sediment | Mineral | | Ion- | sediment | Mineral |
| | | exchangeable | phase | phase | Full-phase | exchangeable | phase rare | phase rare |
| | Rare | phase rare | rare | rare | rare earth | phase rare | earth | earth |
| | earth | earth | earth | earth | leaching | earth leaching | leaching | leaching |
| | grade/wt % | grade/wt % | grade/wt % | grade/wt % | efficiency/% | efficiency/% | efficiency/% | efficiency/% |
| Example 1 | 0.0739 | 0.056 | 0.0179 | 0.00156 | 82.10 | 90.13 | 53.22 | 43.18 |
| Example 2 | 0.0739 | 0.056 | 0.0179 | 0.00156 | 81.06 | 91.55 | 43.81 | 50.62 |
| Example 3 | 0.0739 | 0.056 | 0.0179 | 0.00156 | 85.80 | 92.33 | 60.81 | 52.33 |
| Example 4 | 0.0739 | 0.056 | 0.0179 | 0.00156 | 90.19 | 95.82 | 67.32 | 60.18 |
| Example 5 | 0.0739 | 0.056 | 0.0179 | 0.00156 | 90.21 | 93.86 | 72.35 | 73.92 |
| Example 6 | 0.0739 | 0.056 | 0.0179 | 0.00156 | 78.95 | 88.63 | 45.20 | 39.85 |
| Example 7 | 0.0739 | 0.056 | 0.0179 | 0.00156 | 80.14 | 90.67 | 43.85 | 38.62 |
| Example 8 | 0.0739 | 0.056 | 0.0179 | 0.00156 | 84.63 | 89.62 | 63.80 | 59.75 |
| Example 9 | 0.0739 | 0.056 | 0.0179 | 0.00156 | 82.60 | 91.50 | 50.31 | 50.85 |
| Example 10 | 0.0739 | 0.056 | 0.0179 | 0.00156 | 87.91 | 92.33 | 68.65 | 62.37 |
| Example 11 | 0.107 | 0.086 | 0.019 | 0.002 | 90.99 | 96.87 | 66.72 | 68.6 |
| Example 12 | 0.107 | 0.086 | 0.019 | 0.002 | 89.09 | 95.18 | 63.50 | 70.26 |
| Example 13 | 0.107 | 0.086 | 0.019 | 0.002 | 91.76 | 94.86 | 80.17 | 68.65 |
| Example 14 | 0.107 | 0.086 | 0.019 | 0.002 | 92.86 | 96.86 | 77.34 | 68.52 |
| Example 15 | 0.107 | 0.086 | 0.019 | 0.002 | 85.11 | 90.63 | 62.88 | 58.75 |
| Example 16 | 0.107 | 0.086 | 0.019 | 0.002 | 85.36 | 90.83 | 63.75 | 55.2 |
| Example 17 | 0.107 | 0.086 | 0.019 | 0.002 | 88.60 | 91.55 | 77.30 | 69.22 |
| Example 18 | 0.107 | 0.086 | 0.019 | 0.002 | 85.58 | 90.62 | 65.50 | 59.67 |
| Example 19 | 0.107 | 0.086 | 0.019 | 0.002 | 82.92 | 88.92 | 58.65 | 55.3 |
| Example 20 | 0.107 | 0.086 | 0.019 | 0.002 | 89.60 | 92.57 | 78.63 | 66.08 |
| Example 21 | 0.107 | 0.086 | 0.019 | 0.002 | 89.04 | 91.88 | 78.92 | 63.28 |
| Example 22 | 0.107 | 0.086 | 0.019 | 0.002 | 88.86 | 92.53 | 75.30 | 59.88 |
| Example 23 | 0.107 | 0.086 | 0.019 | 0.002 | 86.91 | 89.68 | 77.62 | 55.92 |
| Example 24 | 0.107 | 0.086 | 0.019 | 0.002 | 87.42 | 90.18 | 78.05 | 57.53 |
| Example 25 | 0.107 | 0.086 | 0.019 | 0.002 | 84.17 | 88.75 | 66.8 | 52.19 |
| Example 26 | 0.107 | 0.086 | 0.019 | 0.002 | 88.36 | 92.13 | 73.18 | 70.2 |
| Comparative | 0.107 | 0.086 | 0.019 | 0.002 | 62.09 | 77.25 | 0 | 0 |
| Example 1 | | | | | | | | |
| Comparative | 0.107 | 0.086 | 0.019 | 0.002 | 60.71 | 75.53 | 0 | 0 |
| Example 2 | | | | | | | | |
| Comparative | 0.0739 | 0.056 | 0.0179 | 0.00156 | 78.17 | 85.33 | 54.01 | 20.02 |
| Example 3 | | | | | | | | |
| Comparative | 0.0739 | 0.056 | 0.0179 | 0.00156 | 57.08 | 75.33 | 0 | 0 |
| Example 4 | | | | | | | | |
| Comparative | 0.0739 | 0.056 | 0.0179 | 0.00156 | 63.68 | 84.03 | 0 | 0 |
| Example 5 | | | | | | | | |
| Comparative | 0.0739 | 0.056 | 0.0179 | 0.00156 | 86.54 | 94.32 | 60.25 | 22.31 |
| Example 6 | | | | | | | | |
| Comparative | 0.0739 | 0.056 | 0.0179 | 0.00156 | 63.10 | 83.27 | 0 | 0 |
| Example 7 | | | | | | | | |
| Comparative | 0.0739 | 0.056 | 0.0179 | 0.00156 | 68.26 | 90.08 | 0 | 0 |
| Example 8 | | | | | | | | |

Notes:
the rare earth leaching efficiency in terms of ion-exchangeable phase, colloidal sediment phase, and mineral phase were calculated based on the rare earth content of the corresponding phases, and the full-phase rare earth leaching efficiency was calculated based on the rare earth leaching efficiency in terms of the above three phases.

As shown in Table 5, in the leaching method according to the present disclosure, the full-phase rare earth leaching efficiency is in a range of 78.95% to 92.86%; the ion-exchangeable phase rare earth leaching efficiency is in a range of 88.63% to 96.87%; the colloidal sediment phase rare earth leaching efficiency is in a range of 43.81% to 80.17%; and the mineral phase rare earth leaching efficiency is in a range of 38.62% to 73.92%. It shows that, when rare earths in IAREO is leached by using the organic acid leaching agent or organic acid/chemical leaching agent compound leaching agent, the leaching of ion-exchangeable phase rare earths is effectively improved and the synchronized leaching of colloidal sediment phase rare earths and mineral phase rare earths is realized. In particular, higher leaching efficiency of colloidal sediment phase and mineral phase rare earths are achieved when multiple organic acids were used in combination. Moreover, the leaching agents as discussed above could also bring necessary nutrient elements to the mine soil, and supplement necessary organic matters for the mine soil after leaching. In this way, the aborigine microorganisms in the soil on the mine were quickly activated, thereby realizing rapid recovery of the mine soil ecology after leaching. The leaching agent(s) shows high leaching efficiency and eco-friendliness.

In summary, the existing IAREO mining technology can only realize the mining of ion-exchangeable phase rare earths, while the colloidal sediment phase rare earths and mineral phase rare earths that account for a certain proportion have not been mined and utilized. However, the organic acid-containing leaching agent used in the present disclosure can leach out the ion-exchangeable phase rare earths in the IAREO by an ion exchange method based on H⁺ or H⁺-chemical leaching agent cations combination. Meanwhile, organic acid ions can complex with rare earth ions to reduce re-adsorption of rare earth ions onto clay minerals, thereby reducing the dosage of leaching agent while achieving efficient leaching of the ion-exchangeable phase rare earths. In addition, the organic acid in the leaching agent can also realize the dissolution and leaching of easily dissolved colloidal sediment phase rare earths and mineral phase rare earths mainly existing in hydroxides, oxides, carbonates, and organic bonded states. Rare earths that are difficult to dissolve are reduced to form low-valent rare earth ions by the reducing organic acid and leached out, thereby achieving simultaneous enhanced leaching of rare earths in the ion-exchangeable phase, colloidal sediment phase, and mineral phase. In this way, a leaching efficiency of the full-phase rare earth in the IAREO is improved, thereby reducing the waste of rare earth resources. The organic acid used as the leaching agent and the organic acid/chemical leaching agent compound leaching agent can avoid or reduce ammonia-nitrogen and magnesium accumulation pollution caused by chemical leaching agents such as ammonium sulfate and magnesium sulfate. The organic acid leaching agent remaining in the mine soil can be quickly converted by microorganisms, thus reducing ecological recovery time of IAREO mines. Therefore, the leaching agent has better application value.

The above are merely preferred embodiments of the present disclosure. It should be noted that several improvements and modifications may further be made by a person of ordinary skill in the art without departing from the principle of the present disclosure, and such improvements and modifications should also be deemed as falling within the scope of the present disclosure.

What is claimed is:

1. A method for leaching full-phase rare earth from an ion-adsorption type rare earth ore (IAREO), comprising the step of
conducting rare earth leaching on the IAREO by using an organic acid-containing leaching solution, to obtain a rare earth leaching liquor,
wherein the organic acid-containing leaching agent comprises an organic acid leaching agent or an organic acid-chemical compound leaching agent, and a solvent in the organic acid-containing leaching agent is water;
an organic acid in the organic acid-containing leaching agent comprises one or more selected from the group consisting of ascorbic acid, gluconic acid, lactobionic acid, malic acid, citric acid, isobutyric acid, formic acid, and glyoxylic acid; and
a molar ratio of an organic acid to a chemical agent in the organic acid-chemical compound leaching agent is in a range of 1:(0.10-12); and the chemical agent in the organic acid-chemical compound leaching agent comprises one or more selected from the group consisting of a water-soluble ammonium salt, a water-soluble magnesium salt, a water-soluble potassium salt, a water-soluble sodium salt, a water-soluble calcium salt, a water-soluble ferric salt, and a water-soluble ferrous salt.

2. The method as claimed in claim 1, wherein a total concentration of the organic acid in the organic acid leaching agent is in a range of 0.005 mol/L to 2 mol/L; and
the organic acid leaching agent has a pH value of 1 to 6.5.

3. The method as claimed in claim 1, wherein the organic acid in the organic acid leaching agent comprises at least two selected from the group consisting of ascorbic acid, gluconic acid, lactobionic acid, malic acid, citric acid, isobutyric acid, formic acid, and glyoxylic acid.

4. The method as claimed in claim 1, wherein a total concentration of cations in the organic acid-chemical compound leaching agent is in a range of 0.005 mol/L to 2 mol/L; and
the organic acid-chemical compound leaching agent has a pH value of 1 to 7.5.

5. The method as claimed in claim 1, wherein the water-soluble ammonium salt comprises one or more selected from the group consisting of ammonium sulfate, ammonium chloride, and ammonium nitrate;
the water-soluble magnesium salt comprises one or more selected from the group consisting of magnesium sulfate, magnesium chloride, and magnesium nitrate;
the water-soluble potassium salt comprises one or more selected from the group consisting of potassium chloride, potassium sulfate, and potassium nitrate;
the water-soluble sodium salt comprises one or more selected from the group consisting of sodium chloride, sodium sulfate, and sodium nitrate;
the water-soluble calcium salt comprises calcium chloride;
the water-soluble ferric salt comprises ferric chloride; and
the water-soluble ferrous salt comprises at least one of ferrous chloride and ferrous sulfate.

6. The method as claimed in claim 1, wherein a rare earth element in the IAREO comprises one or more selected from the group consisting of lanthanum, cerium, praseodymium, neodymium, promethium, samarium, europium, gadolinium, terbium, dysprosium, holmium, erbium, thulium, ytterbium, lutetium, yttrium, and scandium.

7. The method as claimed in claim 1, wherein a solid-to-liquid ratio of the IAREO to the organic acid-containing leaching agent is in a range of 1 g:(1-12) mL.

8. The method as claimed in claim 1, wherein the rare earth leaching comprises column leaching, in-situ ore leaching, heap leaching, or pool leaching.

9. The method as claimed in claim 8, wherein the organic acid-containing leaching agent during the column leaching has a flow rate of 0.05 mL/min to 5 mL/min; and
the in-situ ore leaching, the heap leaching, and the pool leaching are each independently conducted for 4 h to 24 h.

10. The method as claimed in claim 2, wherein the organic acid in the organic acid leaching agent comprises at least two selected from the group consisting of ascorbic acid, gluconic acid, lactobionic acid, malic acid, citric acid, isobutyric acid, formic acid, and glyoxylic acid.

11. The method as claimed in claim 4, wherein the water-soluble ammonium salt comprises one or more selected from the group consisting of ammonium sulfate, ammonium chloride, and ammonium nitrate;
the water-soluble magnesium salt comprises one or more selected from the group consisting of magnesium sulfate, magnesium chloride, and magnesium nitrate;
the water-soluble potassium salt comprises one or more selected from the group consisting of potassium chloride, potassium sulfate, and potassium nitrate;
the water-soluble sodium salt comprises one or more selected from the group consisting of sodium chloride, sodium sulfate, and sodium nitrate;
the water-soluble calcium salt comprises calcium chloride;
the water-soluble ferric salt comprises ferric chloride; and
the water-soluble ferrous salt comprises at least one of ferrous chloride and ferrous sulfate.

12. The method as claimed in claim 6, wherein a solid-to-liquid ratio of the IAREO to the organic acid-containing leaching agent is in a range of 1 g:(1-12) mL.

13. The method as claimed in claim 6, wherein the rare earth leaching comprises column leaching, in-situ ore leaching, heap leaching, or pool leaching.
